(19) United States
(12) Patent Application Publication
(10) Pub. No.: US 2010/0180061 A1
(43) Pub. Date: Jul. 15, 2010

(54) INTERFACE CONTROL DEVICE

(75) Inventor: Kiyoshi Toshimitsu, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/652,991

(22) Filed: Jan. 6, 2010

(30) Foreign Application Priority Data
Jan. 14, 2009 (JP) 2009-005853

(51) Int. Cl. G06F 13/14; G06F 13/00

(52) U.S. Cl. 710/302; 710/305

(57) ABSTRACT

An interface control device includes a first interface, a second interface, a third interface and an interface controller. The first interface is used to communicate with a first information processing device. The second interface is used to communicate with a second information processing device. The second information processing device is different from the first information processing device. The third interface is used to communicate with a controller of a data-storage medium. The interface controller performs an interface control including transmission of an indication signal through the first interface after the communications through the second interface with the second information processing device are established. The indication signal indicates the first information processing device of the fact that communications through the second interface have been established.

### CROSS-REFERENCE TO RELATED APPLICATIONS

This application is based upon and claims the benefit of priority from the Japanese Patent Application No. 2009-005853, filed on Jan. 14, 2009, the entire contents of which are incorporated herein by reference.

### BACKGROUND OF THE INVENTION

1. Field of the Invention

The present invention relates to an interface control device.

2. Description of the Related Art

A removable data-storage medium such as a memory card is conventionally connected to an information processing device that is used as a host device. The information processing device may be a digital camera, a cellular phone, and a personal computer (PC). Data is transmitted/received between the host device and the memory card through an interface such as a universal serial bus (USB).

JP-A 2006-216011 (KOKAI) discloses a technique to transmit the data stored in the memory card to an other device other than the host (hereinafter, “external read device”). Specifically, the memory card has a communication controller to communicate using wireless medium. The communication controller is configured to be controlled by the external read device. Accordingly, the external read device can receive the data stored in the memory card without operating the host device by a user. In addition, this reference describes that the memory card independently handle an access from the host device and an access from the external read device.

In this reference, the memory card may be used under a circumstance which is mainly accessed by a dedicated read device. However, this reference does not mention a multiple-way communication, which the host devices access to the memory cards of the other host devices each other through their memory card.

In addition, this reference also describes that the memory card is capable of independently handling the access from the host device and the access from the external read device. However, the document provides no specific processing to implement the independent handling of accesses.

JP-A 2008-147871 (KOKAI) discloses a communication system in which a wireless-communication device provided outside of the host device directly controls the memory card connected to the host device. A relaying device including a radio interface is provided between the memory card and the host device. The wireless-communication device transmits a request information to the relaying device. The request information includes an instruction for a hardware control of the memory card. The relaying device controls the memory card according to the hardware control.

However, it is required for the wireless-communication device to use/have a dedicated protocol to control the memory card through the relaying device, in order to realize the communication system.

### SUMMARY OF THE INVENTION

According to one aspect of the invention, an interface control device includes:

a first interface to communicate with a first information processing device;

a second interface to communicate with a second information processing device different from the first information processing device;

a third interface to communicate with a controller of a data-storage medium; and

an interface controller to perform an interface control including a transmission of a indication signal through the first interface to the first information processing device after the communications through the second interface with the second information processing device are established, the indication signal indicating the fact that communications through the second interface have been established.

According to other aspect of the invention, an interface control device includes:

a first interface to communicate with a first information processing device;

a second interface to communicate with a second information processing device different from the first information processing device;

a third interface to communicate with a controller of a data-storage medium; and

an interface controller to perform an interface control including a transmission of a first signal through the second interface, the first signal being received through the first interface, and a transmission of a second signal through the first interface, the second signal being received through the second interface, while an address has been assigned to the controller of the data-storage medium and communications through the second interface with the second information processing device have been established.

According to other aspect of the invention, an interface control device includes:

a first interface to communicate with a first information processing device;

a second interface to communicate with a second information processing device different from the first information processing device;

a third interface to communicate with a controller of a data-storage medium; and

an interface controller to perform an interface control including refusing communications to be performed through the first interface while communications through the second interface are established.

According to other aspect of the invention, an interface control device includes:

a first interface to communicate with a first information processing device;

a second interface to communicate with a controller of a data-storage medium; and

an interface controller to perform an interface control including
transmission of a command containing a first address through the second interface after conversion of a second address in the command into the first address, if the interface controller receives the command containing the second address through the first interface when the first address has been assigned to the controller of the data-storage medium and communications through the first interface have been established; and
transmission of a response through the first interface if the interface controller receives the response to the command through the second interface.

### BRIEF DESCRIPTION OF THE DRAWINGS

FIG. 1 is a block diagram illustrating an interface control device according to a first embodiment and related devices;

FIG. 2 is a block diagram illustrating an interface controller of the interface control device shown in FIG. 1;

FIG. 3 is a block diagram illustrating a system including the interface control device shown in FIG. 1;

FIG. 4 is a sequence diagram illustrating an example of data communications in the system shown in FIG. 3;

FIG. 5 is a sequence diagram illustrating an example of exclusive controls in the system shown in FIG. 3;

FIG. 6 is a sequence diagram illustrating another example of exclusive controls in the system shown in FIG. 3;

FIG. 7 is a sequence diagram illustrating still another example of exclusive controls in the system shown in FIG. 3;

FIG. 8 is a diagram illustrating an example of formats for commands employed in the system shown in FIG. 3;

FIG. 9 is a block diagram illustrating an interface control device according to a second embodiment and related devices;

FIG. 10 is a block diagram illustrating a system including the interface control device shown in FIG. 9;

FIG. 11 is a sequence diagram illustrating another example of data communications in the system shown in FIG. 3; and

FIG. 12 is a sequence diagram illustrating still another example of data communications in the system shown in FIG. 3.

### DETAILED DESCRIPTION OF THE INVENTION

The embodiments will be explained with reference to the accompanying drawings.

### Description of the First Embodiment

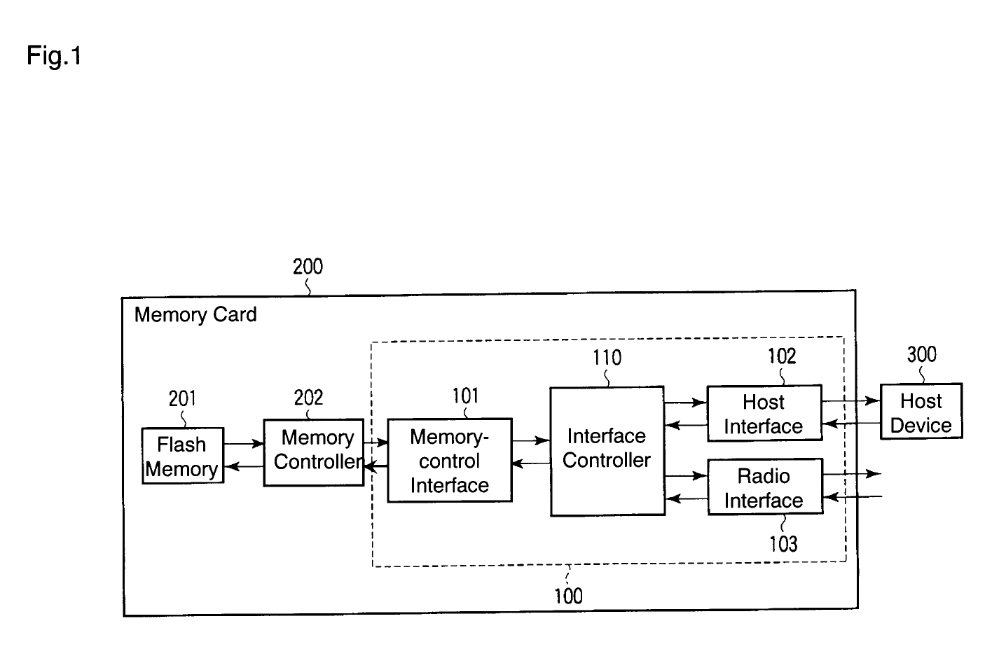

As FIG. 1 illustrates, an interface control device 100 according to a first embodiment of the invention includes a memory-control interface 101, a host interface 102, a radio interface 103, and an interface controller 110.

As FIG. 1 shows, the interface control device 100 may be provided as a dedicated circuit provided in a memory card 200, as an adapter connecting the memory card 200 to a host device 300, or as a dedicated circuit provided in the adapter, for example.

The memory card 200 may be a memory card, which conforms to what is known as the SD standard (Secure Digital standard), such as an SD card, a mini SD card, and a micro SD card. Alternatively, the memory card 200 may be a memory card of other kinds including a multi-media card (MMC). The memory card 200 includes a flash memory 201 and a memory controller 202. The flash memory 201 is configured to store data. The memory controller 202 is configured to perform hardware control on the flash memory 201 so that data can be read from and written into the flash memory 201.

The host device 300 is an information processing device, such as a digital camera, a cellular phone, and a PC. The host device 300 includes a card slot into which the memory card 200 is to be inserted.

The memory-control interface 101 is an interface to exchange data between the interface controller 110 and the memory controller 202.

The host interface 102 is an interface to exchange data between the interface controller 110 and the host device 300. The host interface 102 includes plural signal lines. While a memory controller in an ordinary memory card includes a host interface to exchange data with the host device, the interface control device 100 is required to include the host interface 102 independently, since the interface control device 100 is positioned between the memory controller 202 and the host device 300.

Signals transmitted from the host device 300 are analyzed by the interface control device 100, which will be described later. The signals thus analyzed are transmitted to the memory controller 202 through the memory-control interface 101, if necessary. If no modifications are made to the configuration of the memory controller 202, the signals transmitted by the host device 300 through the host interface 102 are basically the same signals as those transmitted through the memory-control interface 101 to the memory controller 202. In addition, the signals transmitted by the memory controller 202 to the memory-control interface 101 are also basically the same as those transmitted by the host interface 102 to the host device 300.

The radio interface 103 is an interface to exchange data between the interface controller 110 and a radio interface that is connected to an external device different from the host device 300. The radio interface 103 wirelessly communicates with the radio interface connected to the external device in compliance with Bluetooth®, WiFi®, or the like, for example. The radio interface 103 and the wireless communications construct part of a wireless local area network (LAN) or a wireless personal area network (PAN). Note that even if the radio interface 103 is replaced with a wire-communication interface, the same effects that are obtainable by the interface control device 100 according to the first embodiment can be obtained. For example, the radio interface 103 may be replaced with a wire-communication interface to perform wire communications with another wire-communication interface that is connected to an external device. Such wire communications can be implemented by USBs.

The interface controller 110 performs overall controls on the memory-control interface 101, the host interface 102, and the radio interface 103. For example, the interface controller 110 receives inputs of signals transmitted by the memory-control interface 101, the host interface 102, or the radio interface 103, and determines which one of the memory-control interface 101, the host interface 102, and the radio interface 103 should receive each of signals transmitted by the interface controller 110 in response to the received signals. The signals include commands for instructions of the kinds of hardware controls that the memory controller 202 should perform. The signals also include responses corresponding respectively to the commands. In addition, before transmitting each input signal, the interface controller 110 may replace a parameter (e.g., relative card address, RCA) stored in the signal with another value. In addition, the interface controller 110 may spontaneously generate a response corresponding to each command, and may transmit the response back to where the command has come from.

For example, if the interface controller 110 receives a signal through the memory-control interface 101 and if the received signal is a response corresponding to a command received through the host interface 102, the interface controller 110 transmits the response to the host interface 102. In addition, if the interface controller 110 receives a signal through the memory-control interface 101, and if the received signal is a response corresponding to a command received through the radio interface 103, the interface controller 110 transmits the response to the radio interface 103. Moreover, if the interface controller 110 receives a response through the radio interface 103, the interface controller 110 transmits the response to the host interface 102.

A power-supply voltage to the interface control device 100 is supplied from the host device 300 through one of the signal lines included in the host interface 102. The power-supply voltage is also supplied to the memory controller 202 through the interface controller 110 and the memory-control interface 101. In addition, the host interface 102 is capable of being added to or removed from the configuration without shutting down the system (i.e., the host interface 102 supports hot swapping). Accordingly, even if the memory card 200 is inserted into the card slot after the booting of the host device 300, the host device 300 can recognize the memory card 200 without rebooting the host device 300.

In addition, the power-supply voltage is also supplied to the radio interface 103 through the interface controller 110. Triggered by the supply of the power-supply voltage, the radio interface 103 may execute searching processing to find an external device that is capable of performing wireless communications. Note that the interface controller 110 may appropriately restrict the actions of the radio interface 103 for the purpose of avoiding wasteful power consumption. For example, the interface controller 110 may restrict the actions of the radio interface 103 if the interface controller 110 receives an input of a non-selection signal through the host interface 102, and if the received signal instructs that the memory card 200 should be excluded from the possible targets of data exchanges with the host device 300. Specifically, the interface controller 110 may disconnect the communications through the radio interface 103, or may switch the operational modes of the radio interface 103 to the low-power-consumption mode.

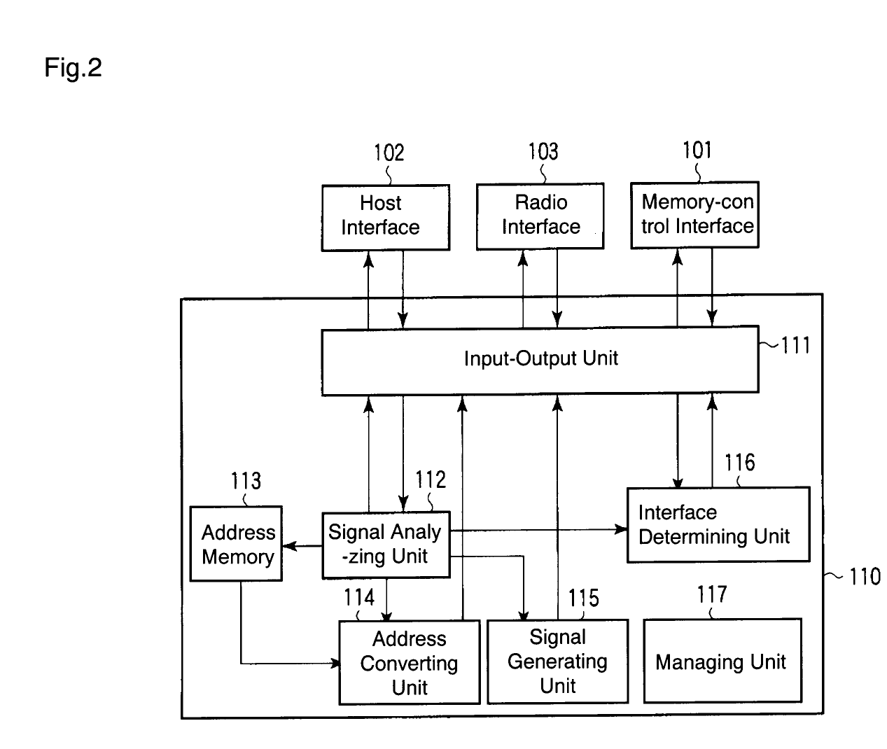

As FIG. 2 illustrates, the interface controller 110 includes an input-output unit 111, a signal analyzing unit 112, an address memory 113, an address converting unit 114, a signal generating unit 115, an interface determining unit 116, and a managing unit 117.

The input-output unit 111 receives inputs of signals transmitted by the memory-control interface 101, the host interface 102, or the radio interface 103. The input-output unit 111 transmits each of the signals received from the memory-control interface 101, the host interface 102, or the radio interface 103 to the signal analyzing unit 112. In addition, the input-output unit 111 outputs signals through one of the memory-control interface 101, the host interface 102, and the radio interface 103, while which interface should be used to this end is determined by the interface determining unit 116.

The signal analyzing unit 112 analyzes the signals received from the input-output unit 111. Specifically, the signal analyzing unit 112 analyzes from which one of the memory-control interface 101, the host interface 102, and the radio interface 103 each signal has been inputted.

If the signal includes a parameter representing address information, such as an RCA, the signal analyzing unit 112 acquires the address information. If the address information is one that has to be held, the signal analyzing unit 112 transmits the address information to the address memory 113. An example of the address information that has to be held is an RCA which has been acquired through the memory-control interface 101 and which represents the address of the memory card 200. The address memory 113 holds the address information received from the signal analyzing unit 112.

If the address information acquired by the signal analyzing unit 112 from a signal is one that has to be replaced with address information held by the address memory 113, the signal analyzing unit 112 transmits the signal to the address converting unit 114. The address converting unit 114 converts the address information included in the signal transmitted by the signal analyzing unit 112 into the address information held by the address memory 113. The address converting unit 114 inputs the resultant signal after the conversion, into the input-output unit 111.

In addition, if the signal generating unit 115 is capable of spontaneously generating a response to a signal, the signal analyzing unit 112 transmits the signal to the signal generating unit 115. The signal generating unit 115 generates a signal to be a reply to the signal received from the signal analyzing unit 112, and inputs the signal thus generated into the input-output unit 111. In addition, the signal generating unit 115 may generate signals of various kinds other than the response described above.

The managing unit 117 manages the input-output unit 111, the signal analyzing unit 112, the address memory 113, the address converting unit 114, the signal generating unit 115, and the interface determining unit 116.

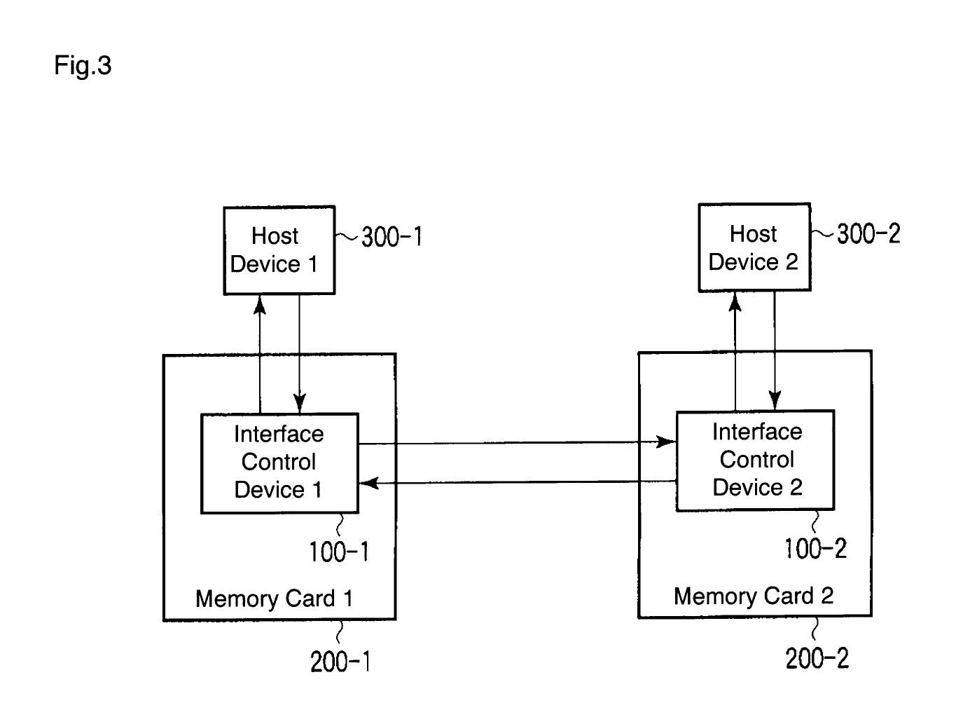

Subsequently, a system including the interface control device 100 according to the first embodiment will be described below by referring to FIG. 3. The system includes a host device 300-1, a memory card 200-1 that is connected to the host device 300-1, a host device 300-2, and a memory card 200-2 that is connected to the host device 300-2. The memory card 200-1 includes an interface control device 100-1 whereas the memory card 200-2 includes an interface control device 100-2. Note that in FIG. 3, each of the interface control device 100-1 and the interface control device 100-2 has a configuration that is identical to the configuration of the interface control device 100.

In the system illustrated in FIG. 3, the host device 300-1 exchanges data with a memory controller 202-1 provided in the memory card 200-1, through the interface control device 100-1. In addition, the host device 300-1 exchanges data with a memory controller 202-2 provided in the memory card 200-2, through the interface control device 100-1 and the interface control device 100-2. Meanwhile, the host device 300-2 exchanges data with the memory controller 202-2 through the interface control device 100-2. In addition, the host device 300-2 exchanges data with the memory controller 202-1 through the interface control device 100-2 and the interface control device 100-1.

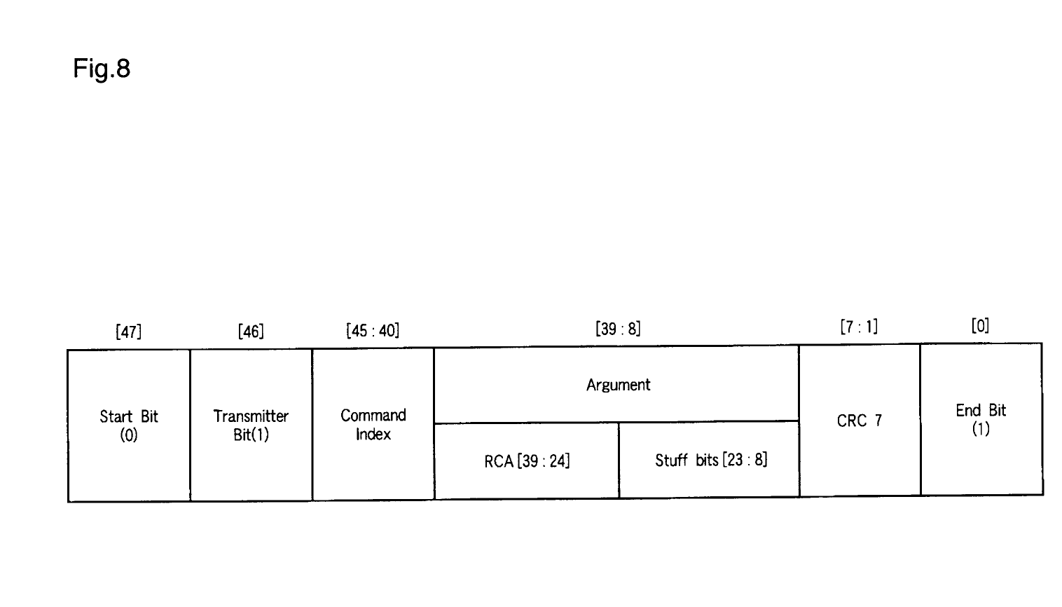

In the system illustrated in FIG. 3, both the memory card 200-1 and the memory card 200-2 are SD cards. Ordinarily, an SD card receives a signal called command from a host device. In response to the command, a memory controller provided in the SD card executes various kinds of processing such as initialization processing for the SD card and a reading or writing processing. Then, the SD card generates a signal called a response as the reply to the command, and transmits the signal thus generated back to the host device. For example, in the initialization processing, the SD card assigns an RCA, whereas the host device selects the SD card and acquires memory information. Specifically, the host device transmits a command 3 to request the SD card to transmit the RCA through a bus connected to the SD card. Note that the bus used here is a star-type bus. Upon receiving the command 3, the SD card transmits the RCA to the host device through a response 6 frame. Once the execution of the series of processing related to the command 3 has finished, the operational mode of the SD card is switched to data transfer mode. In the data transfer mode, the SD card transmits commands received from the host device to plural buses. The RCA is assigned as an argument in a command of various kinds such as a command 7, a command 9, a command 10, and a command 13. The command 7 causes the host device to select the SD card that the host device will read data from or that the host device will write data into. The commands 9 and 10 cause the host device to read the content of the card specific data (CSD) register and that of the card identification (CID) register respectively before the host device selects the SD card. The command 13 causes the host device to read the content of the status register irrespective of whether the host device has or has not selected the SD card. Each of the commands is constituted of 48 bits illustrated in FIG. 8, for example. Accordingly, the host device generates each command by storing the RCA of a desired SD card in the RCA field. Note that in the format illustrated in FIG. 8, the command index stored in the command index field is used to identify what kind of command the command is.

Suppose a case where a system like the one illustrated in FIG. 3 is constructed using conventional host devices and conventional memory cards. In this case, among the RCAs of the memory cards, a first one (referred to as a first host device) of the host devices can obtain only the RCA of the memory card that is connected to the first host device. The RCA of the memory card that is connected to the other host device is not available to the first host device. Accordingly, the first host device cannot generate a command storing the RCA of the memory card connected to the other host device, so that the first host device can acquire neither the CSD register information nor the CID register information.

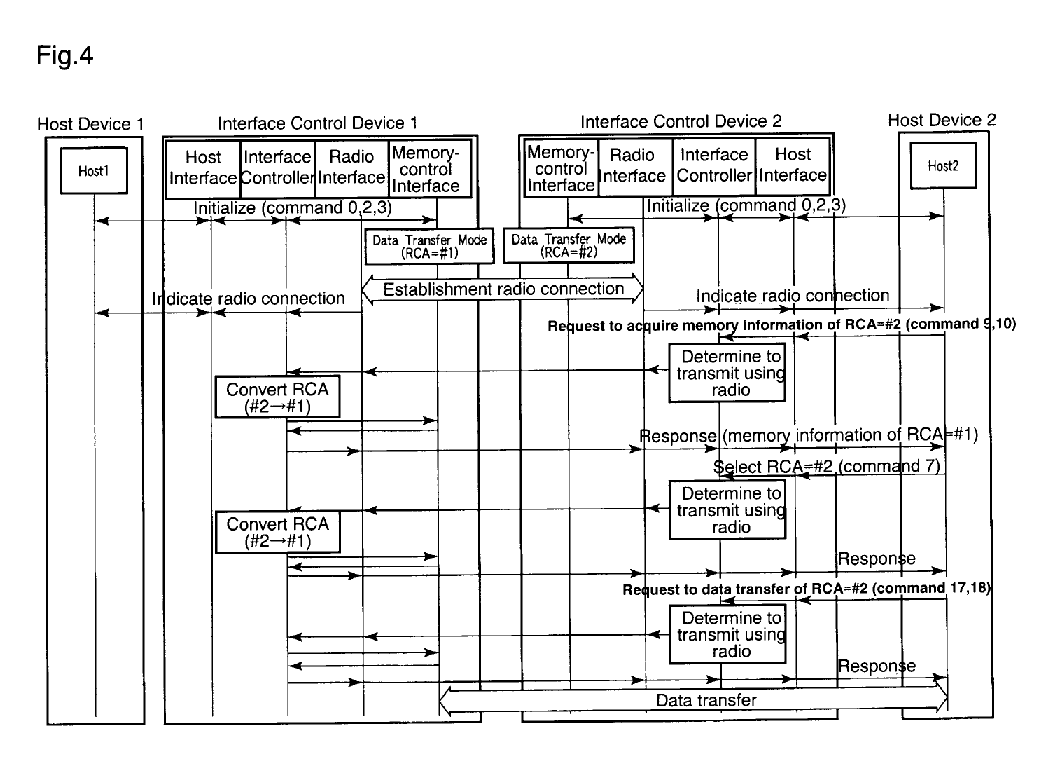

In the system illustrated in FIG. 3, for the purpose of making the host device 300-2 access the memory controller 202-1, data communications are performed in accordance with the sequence illustrated in FIG. 4, for example.

Firstly, the host device 300-1 performs initialization processing of the memory card 200-1. An RCA#1 is assigned to the memory card 200-1 by the initialization processing, and then the operational mode of the memory card 200-1 is switched to the data transfer mode. In the meanwhile, the host device 300-2 performs initialization processing of the memory card 200-2. An RCA#2 is assigned to the memory card 200-2, and then the operational mode of the memory card 200-2 is switched to the data transfer mode. Note that an interface controller 110-1 in the interface control device 100-1 causes an address memory 113-1 to hold the RCA#1 when a command or a response related to the RCA#1 is analyzed. In addition, an interface controller 110-2 in the interface control device 100-2 causes an address memory 113-2 to hold the RCA#2 when a command or a response related to the RCA#2 is analyzed.

Once the initialization processing has been finished, wireless communications are established between a radio interface 103-1 in the interface control device 100-1 and a radio interface 103-2 in the interface control device 100-2. Upon the establishment of the wireless communications, a signal generating unit 115-1 in the interface controller 110-1 generates a notification signal representing the establishment of the wireless communications, and transmits the notification signal to the host device 300-1 through a host interface 102-1. The notification signal is the same as the notification signal, for example, transmitted by the memory controller 202-1 to the host device 300-1 when the memory card 200-1 is connected to the host device 300-1. In addition, a signal generating unit 115-2 in the interface controller 110-2 also generates a notification signal of the same kind as the one described above, and transmits the notification signal to the host device 300-2 through a host interface 102-2.

Upon receiving the notification signal, the host device 300-2 recognizes the establishment of the wireless communications. Then, the host device 300-2 generates a command to acquire the memory information of the memory card 200-1 (e.g., the command 9 or the command 10), and inputs the generated command into the interface controller 110-2 through the host interface 102-2. Note that in practice, the command stores the RCA of the memory card 200-2 (RCA#2). In addition, the command does not always have to be generated. Whether the command will or will not be generated may be determined at the application-program level. For example, the host device 300-2 generates the command, if the host device 300-2 is running an application program to reproduce contents and, at the same time, if the memory card 200-1 stores key information that is necessary to reproduce the contents. Conversely, even if having recognized the establishment of wireless communications, the host device 300-1 does not have to generate the command generation until the host device 300-1 receives a request for the reproduction of contents.

An interface determining unit 116-2 provided in the interface controller 110-2 determines that the command coming from the host interface 102-2 should be outputted to the radio interface 103-2. The radio interface 103-2 transmits the command received from the interface controller 110-2 to the radio interface 103-1.

The radio interface 103-1 inputs the command received from the radio interface 103-2 into the interface controller 110-1. The signal analyzing unit 112-1 provided in the interface controller 110-1 transmits the command received from the radio interface 103-1 to an address converting unit 114-1 provided in the interface controller 110-1. The address converting unit 114-1 converts the RCA stored in the command (RCA#2) into the RCA stored in the address memory 113-1 (RCA#1). The command with the RCA having been converted is inputted into the memory-control interface 101-1. The memory-control interface 101-1 transmits the command received from the interface controller 110-1 to the memory controller 202-1. Since the RCA stored in the command received from the memory-control interface 101-1 coincides with the RCA assigned in the initialization processing, the memory controller 202-1 performs a hardware control corresponding to the command. The response to the command is transmitted to the host device 300-2 though the memory-control interface 101-1, the interface controller 110-1, the radio interface 103-1, the radio interface 103-2, the interface controller 110-2, and the host interface 102-2. For example, if the command transmitted by the host device 300-2 is the command 9 to read the CSD register information, the response stores the CSD register information of the memory card 200-1.

As has been described thus far, in the communications performed in the system illustrated in FIG. 3, if the host device 300-2 accesses the memory card 200-1 connected to the host device 300-1, the host device 300-2 generates a command storing the RCA of the memory card 200-2 connected to the host device 300-2. Then, the RCA stored in the command is replaced with the RCA of the memory card 200-1 by the interface control device 100-1 in the memory card 200-1. Accordingly, the host device 300-2 can access the memory card 200-1 using the same RCA as the RCA of the memory card 200-2. To put it differently, the host device 300-2 can employ the same way of accessing at the time of access to the memory card 200-1 and access to the memory card 200-2. Meanwhile, the memory controller 202-1 can receive a command storing the same RCA as the RCA stored in a command inputted by the host device 300-1 from the host device 300-2. Accordingly, when accessed by the host device 300-2, the memory controller 202-1 has only to transmit a response back to the host device 300-2, the response being the same response as the response upon access by the host device 300-1.

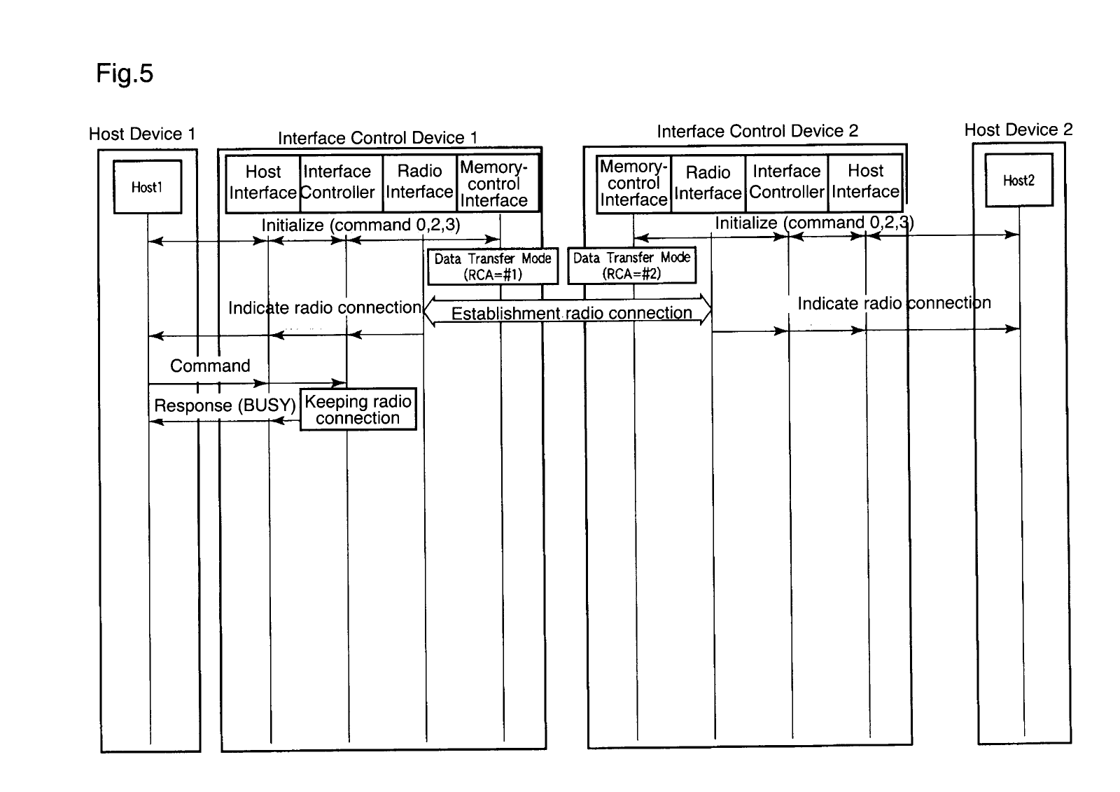

In general, if plural accesses to a shared hardware resource conflict one another, an exclusive control has to be performed. For example, in the system illustrated in FIG. 3, the access of the host device 300-1 to the memory controller 202-1 conflicts with the access of the host device 300-2 to the memory controller 202-1. Specifically, for example, before the memory controller 202-1 that has received a Read command from the host device 300-2 transmits a response back to the host device 300-2, the host device 300-1 might transmit a Write command for the data targeted by the Read command, to the memory controller 202-1. So, it is desirable for the interface control device 100 also to perform some kinds of exclusive controls. Subsequently, an example of possible exclusive controls in the system illustrated in FIG. 3 will be described by referring to FIG. 5.

While there are no wireless communications established between the radio interface 103-1 and radio interface 103-2, the interface control device 100-1 relays commands or responses between the memory controller 202-1 and the host device 300-1. In contrast, while there are the established wireless communications, the interface control device 100-1 relays commands or responses between the memory controller 202-1 and the host device 300-2 instead of the host device 300-1. Accordingly, while there are the established wireless communications, the interface control device 100-1 denies the access of the host device 300-1 to the memory controller 202-1. For example, while there are the established wireless communications, upon receiving a command from the host device 300-1 through the host interface 102-1, the interface controller 110-1 transmits a response representing BUSY of the memory controller 202-1 (a response meaning that the memory controller 202-1 is currently being used) back to the host device 300-1.

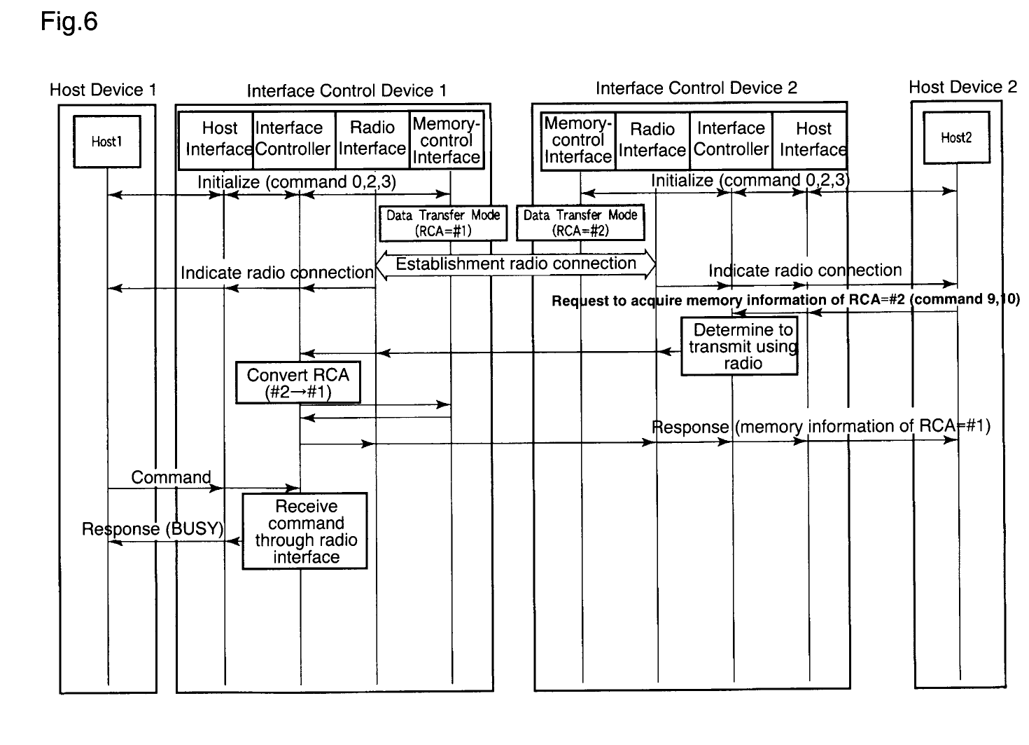

The exclusive control illustrated in FIG. 5 is particularly effective if the communications performed through the radio interface 103-1 is prioritized over the communications performed through the host interface 102-1. For example, the exclusive control illustrated in FIG. 5 is effective if the host device 300-2 is a device to reproduce contents, and, at the same time, if the memory card 200-1 stores key information that is necessary to reproduce the contents. In contrast, if there is no predetermined priority between the communications performed through the host interface 102-1 and the communications performed through the radio interface 103-1, another exclusive control illustrated in FIG. 6 is more desirable. Subsequently, the exclusive control illustrated in FIG. 6 will be described.

While there are no wireless communications established between the radio interface 103-1 and radio interface 103-2, the interface control device 100-1 relays commands or responses between the memory controller 202-1 and the host device 300-1. In addition, even while there are the established wireless communications, the interface control device 100-1 continues to relay commands or responses between the memory controller 202-1 and the host device 300-1 until the interface control device 100-1 actually receives a command through the established wireless communications. In contrast, while there are the established wireless communications, and after the interface control device 100-1 receives a command through the established wireless communications, the interface control device 100-1 relays commands or responses between the memory controller 202-1 and the host device 300-2 instead of the host device 300-1, but the interface control device 100-1 denies the access of the host device 300-1 to the memory controller 202-1. For example, while there are the established wireless communications, and after the interface control device 100-1 receives a command through the wireless communications, upon receiving a command from the host device 300-1 through the host interface 102-1, the interface controller 110-1 transmits a response representing BUSY of the memory controller 202-1 back to the host device 300-1.

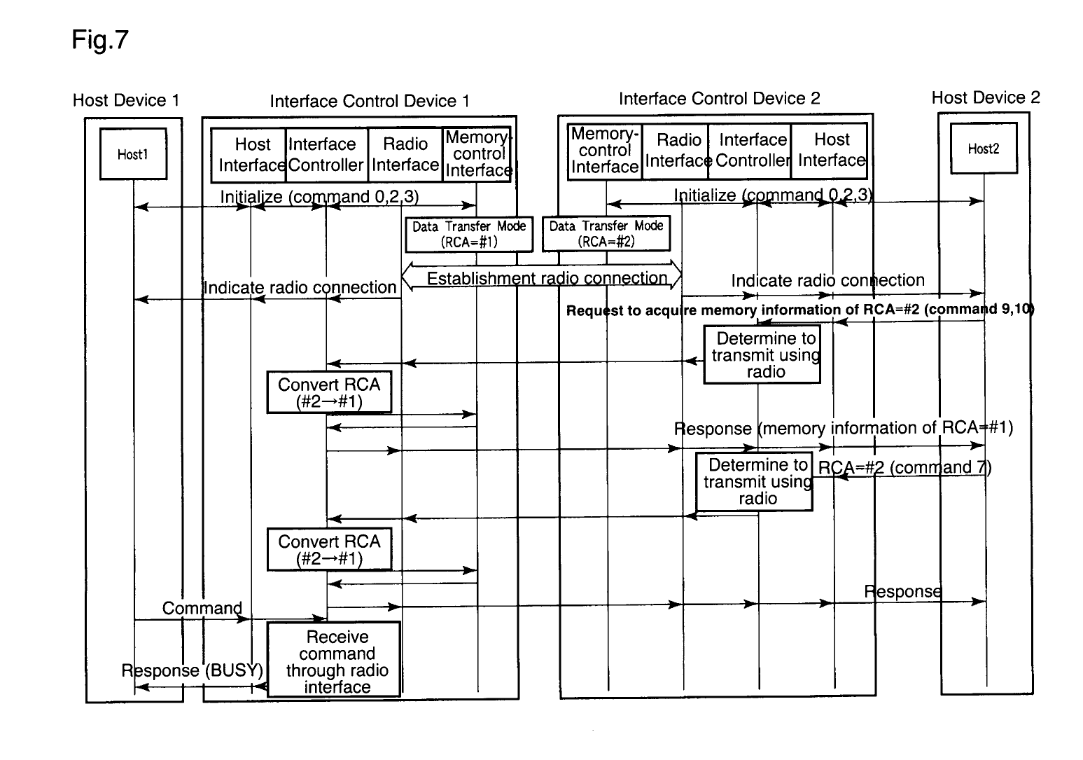

The exclusive control illustrated in FIG. 6 is effective, if, for example, the priority between the communications through the host interface 102-1 and the communications through the radio interface 103-1 is determined at the level of the application program implemented in the host device 300-1 and/or the host device 300-2. Meanwhile, if the priority is not determined between the communications through the host interface 102-1 and the communications through the radio interface 103-1, still another exclusive control illustrated in FIG. 7 is more desirable. Subsequently, the exclusive control illustrated in FIG. 7 will be described.

While there are no wireless communications established between the radio interface 103-1 and the radio interface 103-2, the interface control device 100-1 relays commands or responses between the memory controller 202-1 and the host device 300-1. In addition, even while there are the established wireless communications, the interface control device 100-1 relays commands or responses between the memory controller 202-1 and the host device 300-1, but denies the access of the host device 300-2 to the memory controller 202-1, provided that the interface control device 100-1 receives a selection command (command 7) to select an SD card through the host interface 102-1. For example, while there are the established wireless communications, and, at the same time, after the interface controller 110-1 receives the selection command through the host interface 102-1, upon receiving a command from the host device 300-2 through the radio interface 103-1, the interface controller 110-1 transmits a response representing BUSY of the memory controller 202-1 back to the host device 300-2. In contrast, while there are the established wireless communications, and after the interface control device 100-1 receives the selection command through the established wireless communications, the interface control device 100-1 relays commands or responses between the memory controller 202-1 and the host device 300-2 instead of the host device 300-1, but denies the access of the host device 300-1 to the memory controller 202-1. For example, while there are the established wireless communications, and after the interface controller 110-1 receives the selection command through the wireless communications, upon receiving a command from the host device 300-1 through the host interface 102-1, the interface controller 110-1 transmits a response representing BUSY of the memory controller 202-1 back to the host device 300-1.

According to the exclusive control illustrated in FIG. 7, both the host device 300-1 and the host device 300-2 can access the memory card 200-1. There is one thing that has to be noted here. Suppose a case where the specifications of the memory card 200-1 do not allow consistency to be ensured in the exchanging of the commands and the responses for the initialization processing until the memory card 200-1 is selected. In this case, if the interface controller 110-1 receives a command from any one (will be referred to as the “first interface”) of the radio interface 103-1 and the host interface 102-1 and transmits the command to the memory-control interface 101-1, the interface controller 110-1 has only to deny the access of the other one until the interface controller 110-1 transmits a response corresponding to the command back to that the first interface. For example, if the interface controller 110-1 receives a command (will be referred to as the “first command”) through the radio interface 103-1 and transmits the command to the memory-control interface 101-1, upon receiving a command from the host interface 102-1, the interface controller 110-1 transmits a response representing BUSY of the memory controller 202-1 back to the host interface 102-1 until the interface controller 110-1 transmits back the response to the first command through the radio interface 103-1.

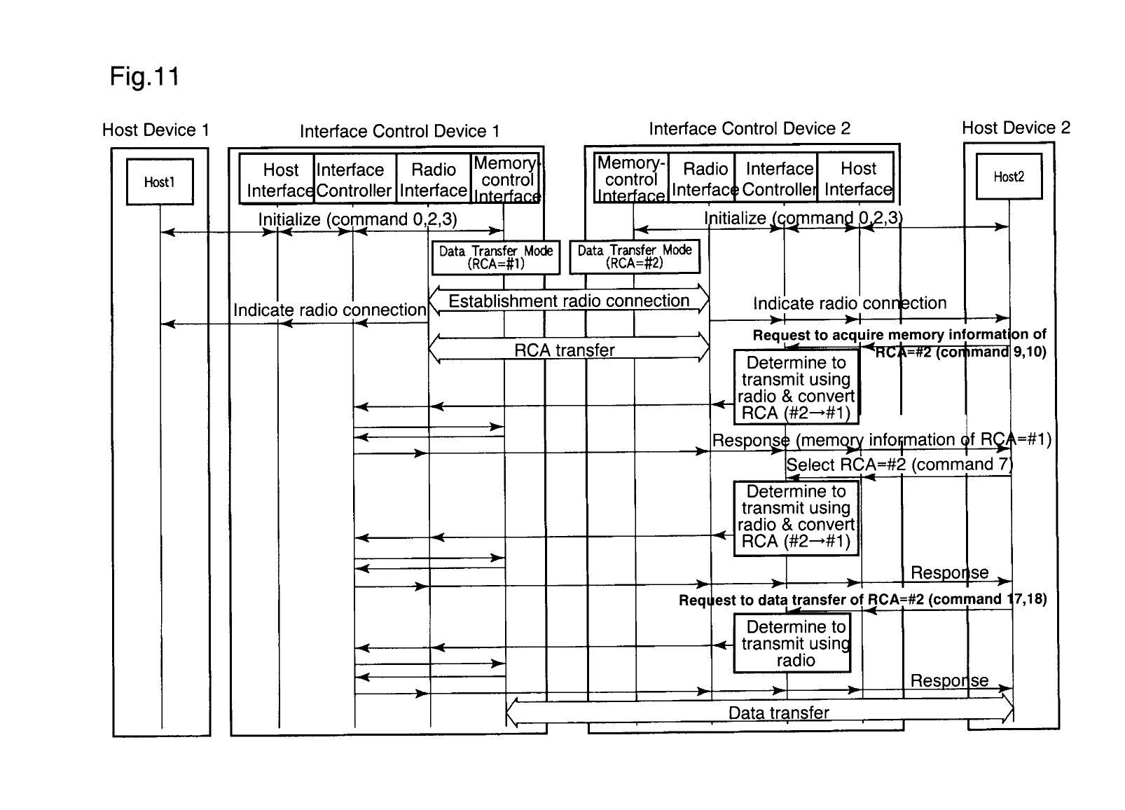

The above-described sequence illustrated in FIG. 4, for the purpose of making the access from the host device 300-2 to the memory card 200-1 possible, the interface control device 100-1 converts the RCA value stored in the command. Alternatively, the interface control device 100-2 may convert the RCA value. Specifically, as FIG. 11 illustrates, once the wireless communications have been established, the interface control device 100-1 and the interface control device 100-2 notify each other of the RCA value assigned to the memory card 200-1 by the initialization processing (RCA#1) and the RCA value assigned to the memory card 200-2 by the initialization processing (RCA#2). Then, the interface control device 100-1 and the interface control device 100-2 respectively cause the address memory 113-1 and the address memory 113-2 to hold the corresponding RCA values. After that, if the interface controller 110-2 determines that the interface controller 110-2 should transmit a command through the radio interface 103-2, the interface controller 110-2 firstly converts the RCA value stored in the command (RCA#2) into the RCA value held in the address memory 113-2 (RCA#1), and then transmits the command with the resultant RCA value through the radio interface 103-2. On the other hand, if the interface controller 110-1 receives the command through the radio interface 103-1, the interface controller 110-1 has only to transmit the command through the memory-control interface 101-1 without converting the RCA value stored in the command.

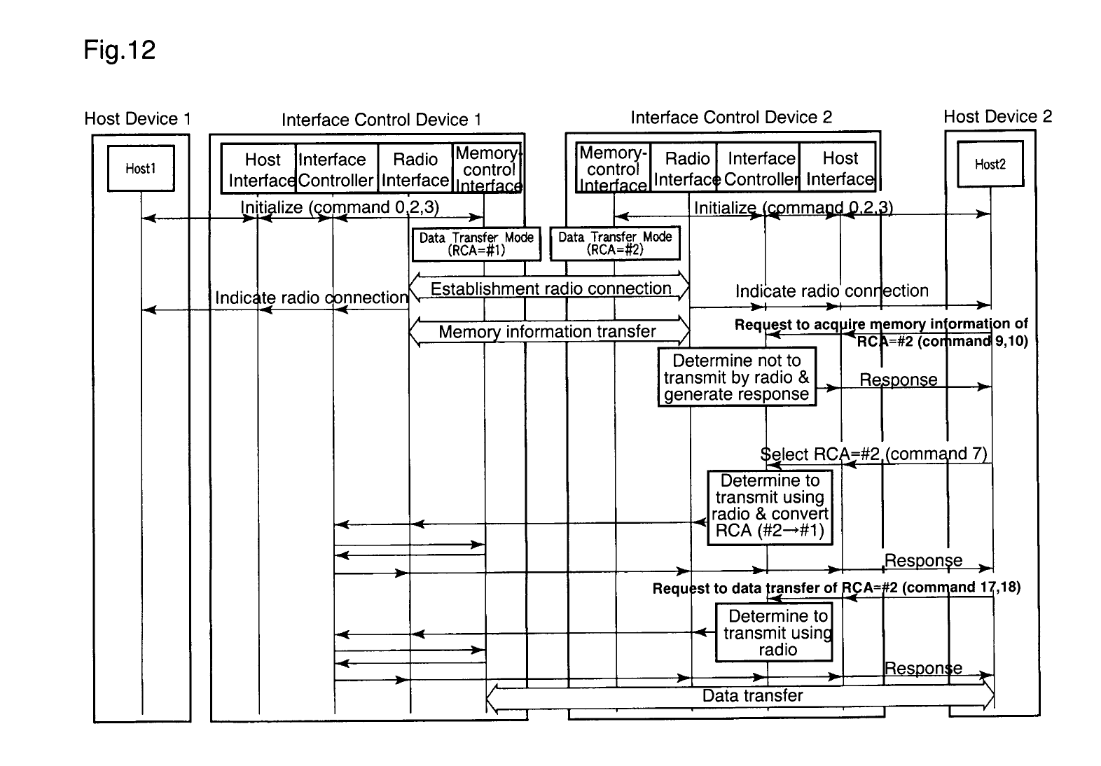

In addition, in the sequence illustrated in FIG. 11, each RCA value is notified of to the counterpart of the communications. Besides the RCA value, memory information, such as the CSD register information and the CID register information, may also be notified of to the counterpart of the communications as FIG. 12 illustrates. If the memory information is notified of to the counterpart of the communications, upon receiving a command requesting the memory information for the counterpart of the communications from the host device 300 through the host interface 102, the interface controller 110 can spontaneously generate a response to the command, and transmit the response thus generated back to the host device 300 through the host interface 102. According to a sequence like the one illustrated in FIG. 12, part of the commands and the responses do not have to be exchanged through wireless communications any longer. Consequently, delays in processing can be reduced.

As has been described thus far, the interface control device according to the first embodiment firstly converts the address information contained in the command into the address information for the memory card to be the access target, and then transmits the command with the resultant address information to the memory controller of the memory card through the memory-control interface. For this reason, the interface control device according to the first embodiment is capable of achieving smooth access from an external device to a data-storage medium connected to a host device, while minimizing changes in the configuration of the memory controller, the host device and the external device.

Note that the interface control device according to the first embodiment is applicable not only to a memory card such as an SD card that is capable of autonomously setting the RCA value but also to a memory card such as an MMC that the RCA value is given to by the host device.

### Description of the Second Embodiment

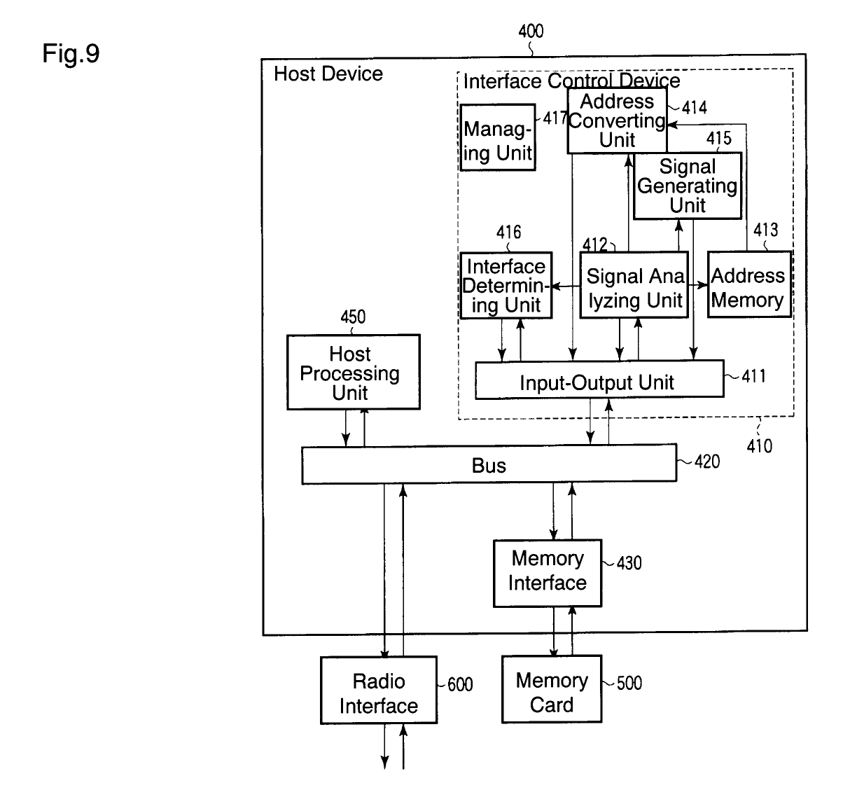

As FIG. 9 illustrates, an interface control device 410 according to a second embodiment of the invention is provided in a host device 400. Besides the interface control device 410, the host device 400 includes a bus 420, a memory interface 430, and a host processing unit 450. In addition, the host device 400 further includes a slot into which a memory card 500 is inserted. Note that the memory card 500 has a configuration that is basically the same as the configuration of the memory card 200 except that the interface control device 100 is not included in the memory card 500. In addition, a radio interface 600 may be either a removable interface such as a network interface card (NIC) or an interface built in the host device 400.

The bus 420 is used as a path for data exchanged among the interface control device 410, the memory interface 430, the host processing unit 450, and the radio interface 600. The data inputted into the bus 420 from any one of the memory interface 430, the host processing unit 450, and the radio interface 600 are inputted into the interface control device 410, temporarily. The interface control device 410 inputs the inputted data back into the bus 420 again so that the data can be directed back to the one of the memory interface 430, the host processing unit 450, and the radio interface 600. The memory interface 430 is an interface that is used when the host device 400 and the memory card 500 exchange data with each other. The host processing unit 450 performs principal processing of the host device 400. The host processing unit 450 includes a CPU and a memory, for example.

The interface control device 410 may be provided, for example, as a dedicated circuit that is built in the host device 400, or as a program that is executable by the host processing unit 450. The interface control device 410 includes an input-output unit 411 that is identical to the input-output unit 111, a signal analyzing unit 412 that is identical to the signal analyzing unit 112, an address memory 413 that is identical to the address memory 113, an address converting unit 414 that is identical to the address converting unit 114, a signal generating unit 415 that is identical to the signal generating unit 115, an interface determining unit 416 that is identical to the interface determining unit 116, and a managing unit 417 that is identical to the managing unit 117.

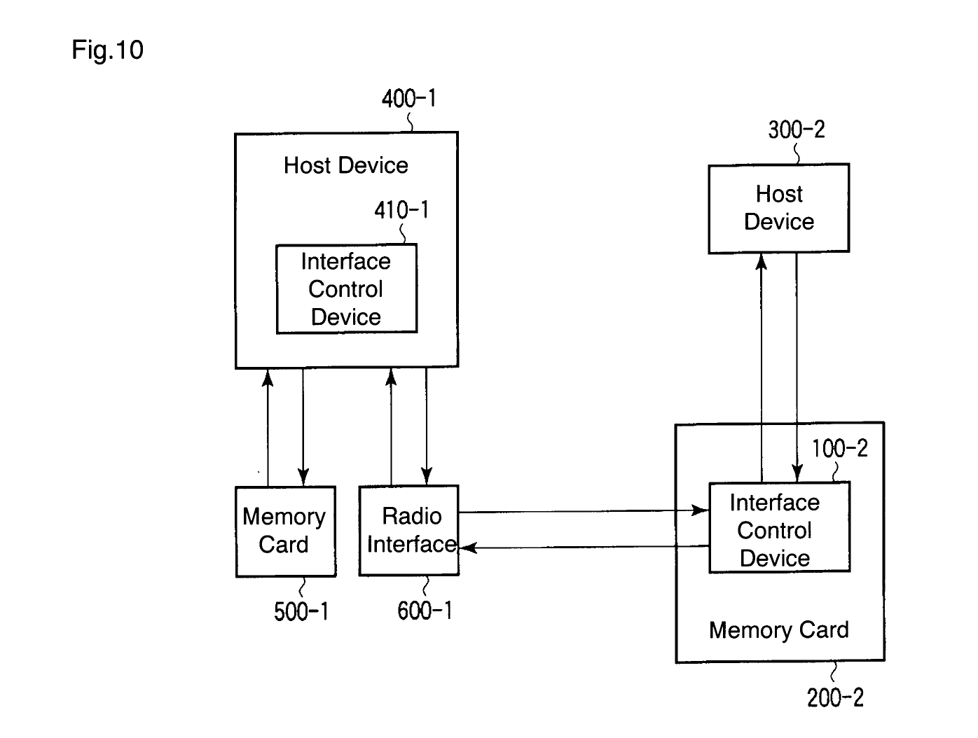

FIG. 10 illustrates an exemplar system including the interface control device 410 according to the second embodiment. The system includes a host device 400-1, a memory card 500-1, a radio interface 600-1, a host device 300-2, and a memory card 200-2. The memory card 500-1 and the radio interface 600-1 are connected to the host device 400-1 whereas the memory card 200-2 is connected to the host device 300-2. The host device 400-1 includes an interface control device 410-1 whereas the memory card 200-2 includes an interface control device 100-2. Note that in the system illustrated in FIG. 10, the interface control device 100-2 has a configuration that is identical to the configuration of the interface control device 100, and the interface control device 410-1 has a configuration that is identical to the configuration of the interface control device 410.

In the system illustrated in FIG. 10, the host device 400-1 exchanges data with a memory controller provided in the memory card 500-1 through the interface control device 410-1, and exchanges data with a memory controller 202-2 provided in the memory card 200-2 through the interface control device 410-1 and the interface control device 100-2. In addition, the host device 300-2 exchanges data with the memory controller 202-2 through the interface control device 100-2, and exchanges data with the memory controller in the memory card 500-1 through the interface control device 100-2 and the interface control device 410-1.

The data communications that are made possible by the system illustrated in FIG. 10 are similar to the data communications that are made possible by the first embodiment. In addition, in the system illustrated in FIG. 10, the host device 300-2 and the memory card 200-2 may be replaced with a host device 400-2, a memory card 500-2, and a radio interface 600-2. The host device 400-2, the memory card 500-2, and the radio interface 600-2 have configurations that are identical to the configurations of the host device 400-1, the memory card 500-1, and the radio interface 600-1, respectively.

As has been described thus far, the interface control device according to the second embodiment is built in the host device. For this reason, the interface control device according to the second embodiment allows an external device to smoothly access a general-purpose data-storage medium connected to the host device.

### Description of the Third Embodiment

The interface control device 100 according to the first embodiment converts appropriately the RCA values contained in commands. As will be described in detail later, if plural RCA values can be assigned to a single memory card, an interface control device 100 according to the third embodiment of the invention chooses and uses one of the plural RCA values that is appropriate for the occasion. The following description is based on an assumption that the interface control device 100 according to the third embodiment is capable of assigning a first RCA value and a second RCA value to a single memory card.

Firstly, a memory card 200 connected to the interface control device 100 is inserted into a host device 300, the first RCA value is assigned to the memory card 200 through the performed by the host device 300. Upon receiving a response storing the first RCA value, an interface controller 110 causes an address memory 113 to hold the first RCA value, and transmits the response to the host device 300 through a host interface 102. From then on, whenever the interface controller 110 receives a response storing the first RCA value, the interface controller 110 transmits the response to the host device 300 through the host interface 102.

Once wireless communications between the interface controller 110 and an external device through a radio interface 103 has been established, the interface controller 110 checks whether the counterpart of communications does or does not include a memory controller that is equivalent to a memory controller 202. If the counterpart of communications includes a memory controller that is equivalent to the memory controller 202, the interface controller 110 transmits a notification of detection of a new device through the host interface 102 so as to cause the host device 300 to recognize the detection of the memory controller. Upon receiving the notification of detection, the host device 300 performs initialization processing on the memory card 200 (i.e., transmits an initialization command). Since the initialization processing on the memory card 200 by the host device 300 has already been done, the interface controller 110 can determine that the initialization command is a command related to initialization processing of the memory controller of the external device. Accordingly, the interface controller 110 transmits the initialization command to the external device through the radio interface 103. The second RCA value is assigned to the memory controller included in the external device, by the initialization command transmitted wirelessly. Upon receiving a response storing the second RCA value through the radio interface 103, the interface controller 110 causes the address memory 113 to hold the second RCA value and transmits the response to the host device 300 through the host interface 102. From then on, whenever the interface controller 110 receives a command storing the second RCA value, the interface controller 110 transmits the command to the external device through the radio interface 103.

The above-described method is taken as an example of a case where the host device 300 accesses the memory of the counterpart of communications. There may be a case, however, where the host device 300 of the counterpart of communications (an external device) accesses the memory controller 202 of the host device 300. An example of this case will be described below.

When the interface controller 110 receives an initialization command through the radio interface 103 from the external device that is the counterpart of communications, the initialization processing on the memory card 200 by the host device 300 has already been done. Accordingly, the interface controller 110 can determine that the initialization command is a command related to the initialization processing performed by the external device. Through the initialization processing performed by the external device, a third RCA value is assigned to the memory card 200. Upon receiving a response storing the third RCA value, the interface controller 110 causes the address memory 113 to hold the third RCA value, and transmits the response to the external device through the radio interface 103. From then on, whenever the interface controller 110 receives a command storing the third RCA value, the interface controller 110 transmits the command to a memory-control interface 101. Upon receiving a response to the command from the memory-control interface 101, the interface controller 110 transmits the response to the external device through the radio interface 103.

As has been described thus far, the interface control device 100 according to the third embodiment allows the host device 300 to access the memory card 200 using the first RCA value, and, at the same time, allows the host device 300 to access the memory of the external device using the second RCA value. Likewise, the interface control device 100 according to the third embodiment allows the external device to access the memory card 200 using the third RCA value. In addition, the interface controller 110 checks which one of the first RCA value and the second RCA value the RCA value stored in a command such as a card selection signal received from the host device 300 is and thereby the interface controller 110 can determine through which one of the radio interface and the memory control interface the command should be transmitted.

In addition, similar exclusive controls to the ones that are applicable to the interface control device 100 according to the first embodiment are also applicable to the interface control device 100 according to the third embodiment. Moreover, when whether the counterpart of communications does or does not include a memory controller is checked, the memory information for the memory card 200 may be transferred to the counterpart of communications. If the counterpart of communications has the memory information, exchanging of commands and responses related to the RCA assignment, the CID information acquisition, and the like can be done in a shorter time (i.e., the processing delay can be reduced).

If the memory card 200 is not a memory card such as an SD card capable of autonomously setting the RCA value but a memory card such as an MMC to which the RCA value is given by the host device, the interface control device 100 according to the third embodiment further uses the processing of converting the RCA value performed by the interface control device 100 according to the first embodiment. The processing of converting the RCA value may be performed either before or after the command is transferred wirelessly.

If the RCA-value conversion is performed before the wireless transfer of the command, the interface controller 110 connected to the host device 300 has to notify the interface controller of the external device of the RCA value of the memory card 200 through the radio interface 103 before the RCA-conversion is performed. If the interface controller of the external device determines that the command having received through the host interface should be transferred through the radio interface, the RCA value stored in the command has only to be converted into the RCA value having been notified of by the memory card 200.

If the RCA-value conversion is performed after the wireless transfer of the command, upon receiving a command 3 to assign an address from the external device through the radio interface 103 and receiving a response 6 to the command 3 through the memory-control interface 101, the interface controller 110 causes the address memory 113 to hold the RCA value stored in the response 6. From then on, the interface controller 110 has only to convert the RCA value stored in the command received through the radio interface 103 into the RCA value held by the address memory 113.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An interface control device comprising:
a first interface to communicate with a first information processing device;
a second interface to communicate with a second information processing device different from the first information processing device;
a third interface to communicate with a controller of a data-storage medium; and
an interface controller to perform an interface control including a transmission of a indication signal through the first interface to the first information processing device after the communications through the second interface with the second information processing device are established, the indication signal indicating the fact that communications through the second interface have been established.

2. An interface control device comprising:
a first interface to communicate with a first information processing device;
a second interface to communicate with a second information processing device different from the first information processing device;
a third interface to communicate with a controller of a data-storage medium; and
an interface controller to perform an interface control including
a transmission of a first signal through the second interface, the first signal being received through the first interface,
and a transmission of a second signal through the first interface, the second signal being received through the second interface,
while an address has been assigned to the controller of the data-storage medium and communications through the second interface with the second information processing device have been established.

3. The interface control device of claim 1, wherein a power-supply voltage is supplied from the first information processing device through the first interface.

4. The interface control device of claim 3, wherein the first interface is hot swappable with the first information processing device.

5. The interface control device of claim 1, wherein if the interface controller receives a non-selection signal not to select the controller of the data-storage medium, through the first interface, the interface controller disconnects the communications performed through the second interface.

6. The interface control device of claim 1, wherein if the interface controller receives a command containing a second address through the second interface after a first address is assigned to the controller of the data-storage medium, the interface controller converts the second address into the first address and then transmits the command through the third interface, and
if the interface controller receives a response to the command through the third interface, the interface controller transmits the response through the second interface.

7. An interface control device comprising:
a first interface to communicate with a first information processing device;
a second interface to communicate with a second information processing device different from the first information processing device;
a third interface to communicate with a controller of a data-storage medium; and
an interface controller to perform an interface control including refusing communications to be performed through the first interface while communications through the second interface with the second information processing device are established.

8. The interface control device of claim 7, wherein while communications through the second interface with the second information processing device are established and if the interface controller receives a signal through the second interface, the interface controller refuses communications to be performed through the first interface.

9. The interface control device of claim 7, wherein while communications through the second interface with the second information processing device are established and if the interface controller receives a selection signal to select the data-storage medium through the second interface, the interface controller refuses communications to be performed through the first interface.

10. The interface control device of claim 1, wherein
if communications through the second interface are established after a first address is assigned to the controller of the data-storage medium, the interface controller receives a second address through the second interface and holds the second address,
then if the interface controller receives a command containing the first address through the first interface, the interface controller converts the first address in the command into the second address, and transmits the command through the second interface, and
then if the interface controller receives a response to the command through the second interface, the interface controller transmits the response through the first interface.

11. The interface control device of claim 1, wherein
if the interface controller receives an assigning command to assign an address through the first interface after a first address is assigned to the controller of the data-storage medium, the interface controller transmits the assigning command through the second interface, and
then if the interface controller receives a response to the assigning command through the second interface, the interface controller holds a second address contained in the response to the assigning command, and indicates the first information processing device of the second address through the first interface.

12. The interface control device of claim 11, wherein
if the command received through the first interface contains the first address, the interface controller transmits the command through the third interface, and
if the command received through the first interface contains the second address, the interface controller transmits the command through the second interface.

13. The interface control device of claim 1, wherein
if the interface controller receives an assigning command to assign an address through the second interface after a first address is assigned to the controller of the data-storage medium, the interface controller transmits the assigning command through the third interface, and
then if the interface controller receives a response to the assigning command through the third interface, the interface controller transmits the response through the second interface and holds a second address contained in the response to the assigning command.

14. The interface control device of claim 13, wherein
if the interface controller receives a response to a command storing the first address from the third interface, the interface controller transmits the response through the first interface, and
if the interface controller receives a response to a command storing the second address from the third interface, the interface controller transmits the response through the second interface.

15. An interface control device comprising:
a first interface to communicate with a first information processing device;
a second interface to communicate with a controller of a data-storage medium; and
an interface controller to perform an interface control including
transmission of a command containing a first address through the second interface after conversion of a second address in the command into the first address, if the interface controller receives the command containing the second address through the first interface when the first address has been assigned to the controller of the data-storage medium and communications through the first interface have been established; and
transmission of a response through the first interface if the interface controller receives the response to the command through the second interface.

16. The interface control device of claim 2, wherein a power-supply voltage is supplied from the first information processing device through the first interface.

17. The interface control device of claim 2, wherein if the interface controller receives a non-selection signal not to select the controller of the data-storage medium, through the first interface, the interface controller disconnects the communications performed through the second interface.

18. The interface control device of claim 2, wherein if the interface controller receives a command containing a second address through the second interface after a first address is assigned to the controller of the data-storage medium, the interface controller converts the second address into the first address and then transmits the command through the third interface, and
if the interface controller receives a response to the command through the third interface, the interface controller transmits the response through the second interface.

19. The interface control device of claim 2, wherein
if communications through the second interface are established after a first address is assigned to the controller of the data-storage medium, the interface controller receives a second address through the second interface and holds the second address,
then if the interface controller receives a command containing the first address through the first interface, the interface controller converts the first address in the command into the second address, and transmits the command through the second interface, and
then if the interface controller receives a response to the command through the second interface, the interface controller transmits the response through the first interface.

20. The interface control device of claim 2, wherein
if the interface controller receives an assigning command to assign an address through the first interface after a first address is assigned to the controller of the data-storage medium, the interface controller transmits the assigning command through the second interface, and
then if the interface controller receives a response to the assigning command through the second interface, the interface controller holds a second address contained in the response to the assigning command, and indicates the first information processing device of the second address through the first interface.

21. The interface control device of claim 2, wherein
if the interface controller receives an assigning command to assign an address through the second interface after a first address is assigned to the controller of the data-storage medium, the interface controller transmits the assigning command through the third interface, and
then if the interface controller receives a response to the assigning command through the third interface, the interface controller transmits the response through the second interface and holds a second address contained in the response to the assigning command.
